(19) United States
(12) Patent Application Publication
(10) Pub. No.: US 2002/0070290 A1
(43) Pub. Date: Jun. 13, 2002

(54) Stripe inhibiting device for surface cleaning heads

(76) Inventor: William J. Krupowicz, Geneva, IL (US)

Correspondence Address: Finnegan, Henderson, Farabow,, Garrett & Dunner, L.L.P., 1300 I Street, N.W., Washington, DC, 20005-3315, US

(21) Appl. No.: 10/006,206

(22) Filed: Dec. 10, 2001

Related U.S. Application Data
(60) Provisional application No. 60/254,079, filed on Dec. 8, 2000.

(51) Int. Cl. B05B 3/00

(52) U.S. Cl. 239/225.1; 239/240

(57) ABSTRACT

A high pressure cleaning head for cleaning surfaces and including a rotatable spray head having rotatable spray arms for directing a cleaning agent to surface to be cleaned by successive overlapping passes of the cleaning head; and a diffuser to inhibit the cleaning action of the spray arms on at least one side of the cleaning head and thereby prevent striping on the surface to be cleaned due to the overlapping passes of the cleaning head.

### CROSS REFERENCE TO RELATED APPLICATIONS

This application claims priority under 35 U.S.C. § 119 based on provisional application No. 60/254,079, filed Dec. 8, 2000, the complete disclosure of which is incorporated by reference.

### BACKGROUND OF THE INVENTION

This invention relates to closed loop surface cleaning systems, and, more particularly, to such cleaning systems of the type disclosed in U.S. Pat. Nos. 5,469,597 and No. 5,704,989, the complete disclosures of which are incorporated herein by reference.

The closed loop cleaning system of the cited patents uses a cleaning head that is similar in appearance to a rotary lawn mower. Instead of a rotating blade, a housing with rotating high pressure sprayer arms are used for open surface cleaning. Cleaning of open surfaces is also done in a similar manner to mowing grass. The cleaning head makes overlapping passes of the open area to be cleaned. As with lawn mowing, the cleaning action typically leaves unattractive traces of its path called striping. This striping can be very unattractive depending on the surface being cleaned. While striping is aggravated by some surface conditions, the real source of the problem is that, as the sprayer arms rotate around, there is inherently more cleaning action along the left and right sides of the rotating sprayer arms than in the forward or rearward areas as the unit moves along. This will vary with the arc length. As overlapping passes are made with the LAW OFFICES cleaning head, the striping effect becomes more pronounced.

### SUMMARY OF THE INVENTION

The advantages and purpose of the invention will be set forth in part in the description which follows, and in part will be obvious from the description, or may be learned by practice of the invention. The advantages and purpose of the invention will be realized and attained by means of the elements and combinations particularly pointed out in the appended claims.

To attain the advantages and in accordance with the purpose of the invention, as embodied and broadly described herein, the invention is an improvement in a high pressure cleaning head having rotatable spray arms for directing a cleaning agent to surface to be cleaned by successive overlapping passes of the cleaning head, the improvement comprising a diffuser to inhibit the cleaning action of the spray arms on at least one side of the cleaning head and thereby prevent striping on the surface to be cleaned due to the overlapping passes of the cleaning head. To significantly reduce or eliminate the appearance problems with striping, diffuser plates are strategically placed on the left and right sides of the cleaning head to partially block the high pressure cleaning spray. By varying the size, location and or the amount of spray blockage, the amount of extra cleaning being done on the side areas can be equalized or reduced to allow for the amount of overlapping that occurs during normal use.

It is to be understood that both the foregoing general description and the following detailed description are exemplary and explanatory only and are not LAW OFFICES restrictive of the invention, as claimed.

### BRIEF DESCRIPTION OF THE DRAWINGS

The accompanying drawings, which are incorporated in and constitute a part of this specification, illustrate an exemplary embodiment of the invention and together with the description, serve to explain the principles of the invention. In the drawings,

FIG. 1 is a perspective view of a mobile cleaning head used with closed loop surface cleaning systems and in which the present invention is particularly suited for use;

FIG. 2 is a composite view depicting multiple paths taken by the cleaning head of FIG. 1 during use;

FIG. 3 is a bottom plan view of the cleaning head of FIG. 1, modified to incorporate the present invention;

FIG. 4 is an enlarged fragmentary cross section taken on line 4-4 of FIG. 3;

and

FIG. 5 is a plan view of a material that may be used as a diffuser in the cleaning head of the present invention.

### DESCRIPTION OF THE PREFERRED EMBODIMENT

Reference will now be made in detail to the present preferred embodiment of the invention, an example of which is illustrated in the accompanying drawings. Wherever possible, the same reference numbers will be used throughout the drawings to refer to the same or like parts.

In accordance with the present invention, a high pressure cleaning head having rotatable spray arms for directing a cleaning agent to surface to be cleaned by successive overlapping passes of the cleaning head, is improved by a diffuser to inhibit the cleaning action of the spray arms on at least one side of the cleaning head and thereby to prevent striping on the surface to be cleaned due to the overlapping passes of the cleaning head.

In the illustrated embodiment, the high pressure cleaning head is generally designated by the reference numeral 10, and is shown to include a generally horizontal, X-shaped frame 12 supported by wheels 14 to be elevated above a surface, such as a floor, street, deck or other surface to be cleaned. The cleaning head 10 is thus adapted to be propelled over such a surface manually by use of a handle 16 extending from the top of the frame 12 to a height convenient for a person to push the cleaning head over the surface.

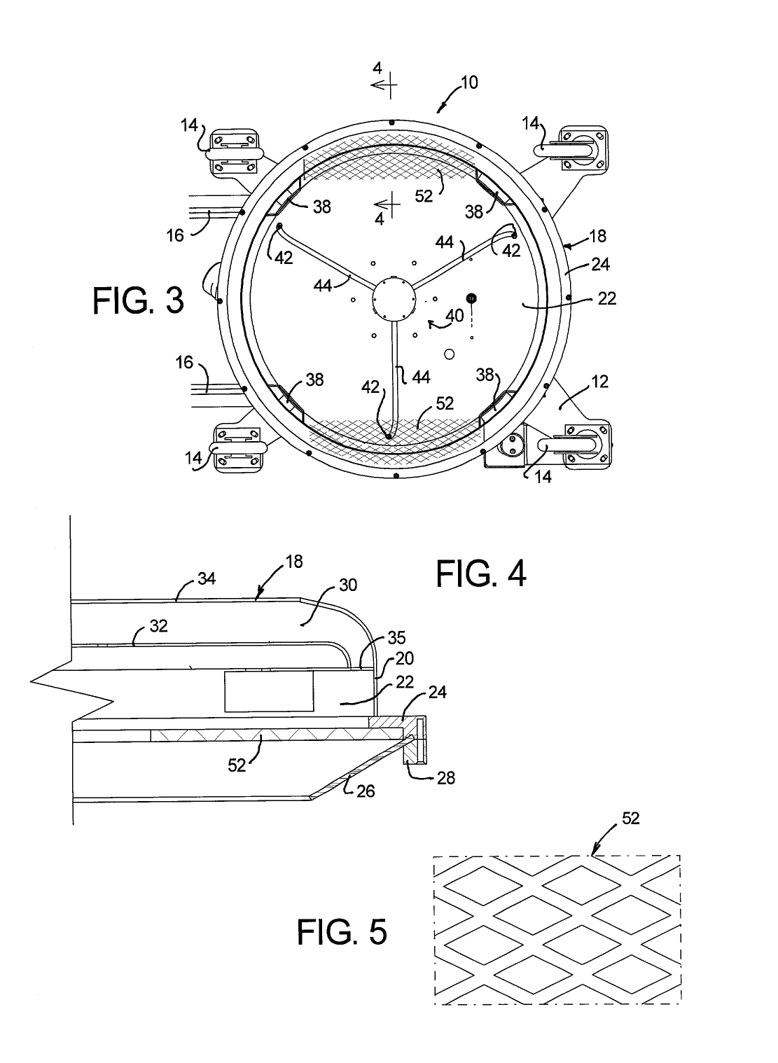

A circular housing 18 is supported under the frame 12 and includes a peripheral skirt portion 20 forming part of a downwardly opening cylindrical cleaning chamber 22, as shown in FIGS. 3 and 4 of the drawings. The cleaning chamber 22 is further defined in part by a ring 24, having a radial cross section of inverted L-shaped configuration and that is welded or otherwise joined with the bottom of the peripheral skirt portion 20, an inwardly sloped, frusto-conical, flexible sealing member 26, and a clamping ring 28 bolted to the ring 24 in a manner to releasably secure the sealing member 26 to the ring 24.

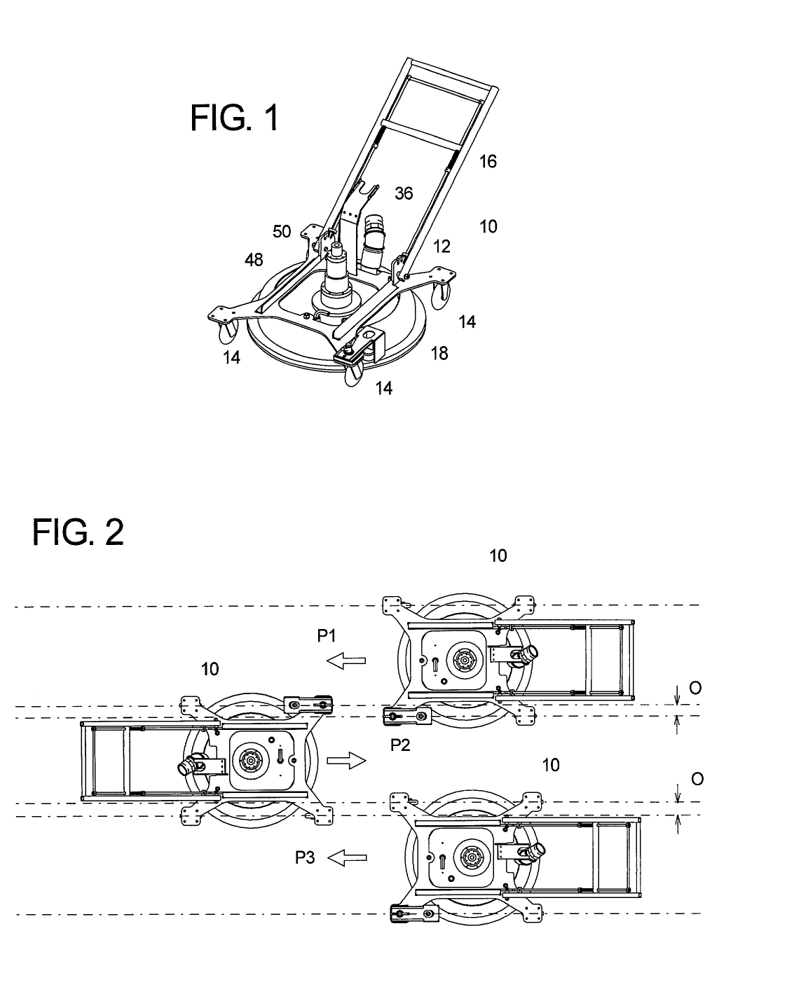

The top of the housing 18 is provided with a suction manifold or chamber 30 between a top wall 32 of the cleaning chamber 22, and a top wall 34 of the housing 18. A peripheral wall 35 seals across downwardly curved portions of the walls 32 and 34. As shown in FIGS. 1, 3, and 4, the suction manifold opens through a fitting 36 (FIG. 1) to which a vacuum hose (not shown) is connected in use of the cleaning head 10. The suction manifold 30 is in communication with the cleaning chamber 22 via ports 38 (FIG. 3) in the peripheral wall 35, thereby subjecting the cleaning chamber 22 to vacuum applied to the fitting 36.

A rotatable cleaning fluid spray head 40 including three nozzles 42 at the ends of arms 44 radiating from a hub 46, in the illustrated embodiment, is supported below the top wall 32 of the cleaning chamber by a journal housing 48 (FIG. 1) on top of the housing 18. A hose fitting 50 is connected during use of the cleaning head 10 by a hose (not shown) to a pressurized supply of cleaning fluid (also not shown) to be sprayed onto the surface to be cleaned by the nozzles 42, with the spray head 40 driven in rotation by acceleration of the cleaning fluid through the nozzles 42, which are inclined to the vertical to the vertical for this purpose.

In use, and as depicted in FIG. 2, the cleaning head 10 is advanced over the surface to be cleaned, much in the same manner as a lawn mower, through adjacent overlapping paths depicted by arrows and marginal-lines in FIG. 2, the arrows being designated P1, P2, and P3. To ensure coverage of the surface to LAW OFFICES be cleaned, the paths P1, P2 and P3 overlap by a relatively small distance O of overlap. As the surface is cleaned by advancing the cleaning head through the adjacent paths, it will be apparent that if the cleaning fluid impinged by the nozzles 42 against the surface to be cleaned remained constant throughout the rotary paths of the nozzles 42, the areas represented by the overlaps O would receive a higher degree of cleaning action than the central regions of the paths P1, P2 and P3. As a result, striping would occur in the surface to be cleaned upon using the cleaning head 10 in the manner described. In addition to the increased cleaning due to the overlap, the tangential relation of the spray nozzles 42 to the circular paths of the nozzles and to the direction of travel would result, by itself, in striping along opposite sides of each path.

In accordance with the present invention, and as shown in FIGS. 3 and 4 of the drawings, at least one, preferably two diffusers 52 are arranged on opposite sides of the downwardly opening cleaning chamber 22 of the cleaning head 10.

The diffusers 52, as shown most clearly in FIG. 3, are preferably formed of a metal mesh or grid through which cleaning fluid must pass as the spray head 40 is rotated to direct cleaning fluid downwardly from the nozzles 42 at the periphery thereof. The diffusers 52 are fixed to an annular surface 53 on the underside of the inverted L-shaped ring 24, preferably by spot welding but other fastening devices, such as screws, bolts, adhesives, and the like can be used. The diffusers 52 disperse the jets of cleaning fluid issuing from the nozzles 42 and thus inhibit the cleaning action at the side edges of the cleaning head 10. As a result, the tendency for over cleaning resulting from overlap of the paths taken by the cleaning head 10 over the surface to be cleaned, and by the circular path of spray nozzles is reduced to avoid striping.

Although the cleaning head 10 is equipped with the suction manifold 30 and vacuum ports 38, as described above, the present invention may be practiced by application of the diffusers 52 to cleaning heads that do not included a vacuum system. In the illustrated embodiment and as shown in FIG. 3, the diffuser 52 is shaped to fit between the vacuum ports 38 so that the flow by suction through the ports 38 will not be obstructed. In cleaning heads where the vacuum ports overlie the diffusers 52 the diffusers may be formed with openings to avoid interference with the vacuum ports. Also, it is to be noted that although two diffusers 52 are used in the illustrated embodiment, a single diffuser 52 on one side only of the cleaning chamber 22 could be used effectively either by increasing the diffusing effect of the single diffuser 52, such as by reducing the effective pass-through characteristics of the metal mesh or grid from which it is formed, or in cleaning surfaces that require a lower cleaning action.

FIG. 5 is a plan view illustrating a metal mesh from which the diffusers 52 may be formed. As shown, the metal mesh is an expanded sheet metal having openings 52a approximately ¾ inch in length, and a metal grid portions 52c approximating the size of a number 10 gauge wire. Other materials may be used for the diffusers, depending on such variables as the number of spray nozzles employed in the cleaning head, the speed of which the spray head 40 is rotated, LAW OFFICES and the like. It is important that the diffusers 52 should be effective to reduce or stop the jets of cleaning fluid from the nozzles 42 for a distance defined by a chord line spaced approximately 2 inches from the outer sides of the skirt portion 20, in order to maximize the reduction in striping, as described above.

In addition to the expanded metal grating or metal mesh illustrated in FIG. 5, other materials may be used for the diffusers 52. For example, they may be made of perforated metal having various size openings, or in some instances, a diffusers 52 may be replaced by solid deflector sheets to completely block the jets of cleaning fluid issuing from the nozzles 42. Where perforated metal is used, for example, it is possible to provide a graduated porosity or pass-through characteristic that would decrease toward the outer edge of the skirt portion 20.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A high pressure cleaning head comprising:
a rotatable spray head having rotatable spray arms for directing a cleaning agent to surface to be cleaned by successive overlapping passes of the cleaning head; and
a diffuser to inhibit the cleaning action of the spray arms on at least one side of the cleaning head and thereby prevent striping on the surface to be cleaned due to the overlapping passes of the cleaning head.

2. The high pressure cleaning head of claim 1, wherein the diffuser is effective to reduce or stop the amount of cleaning action of the spray head.

3. The high pressure cleaning head of claim 2, wherein the diffuser is effective for approximately 2 inches from at least one side of the cleaning head.

4. The high pressure cleaning head of claim 2, wherein the diffuser is an expanded metal grid.

5. The high pressure cleaning head of claim 2, wherein the diffuser is a perforated sheet.

6. The high pressure cleaning head of claim 5, wherein the perforated sheet has perforations graduated in size, and decreasing in size toward the outside of the cleaning head.

7. The high pressure cleaning head of claim 1, wherein two diffusers are located one on each side of the cleaning head.

8. The high pressure cleaning head of claim 2, wherein the diffuser is a solid deflector sheet.
